(19) United States
(12) Patent Application Publication
(10) Pub. No.: US 2011/0025985 A1
(43) Pub. Date: Feb. 3, 2011

(54) PROJECTOR AND CONTROL METHOD

(75) Inventor: Yukihiro Karasawa, Azumino-shi (JP)

Correspondence Address: ADVANTEDGE LAW GROUP, LLC, 922 W. BAXTER DRIVE, SUITE 100, SOUTH JORDAN, UT, 84095, US

(73) Assignee: Seiko Epson Corporation, Tokyo (JP)

(21) Appl. No.: 12/843,252

(22) Filed: Jul. 26, 2010

(30) Foreign Application Priority Data
Jul. 31, 2009 (JP) 2009-178616

(51) Int. Cl. G03B 21/16

(52) U.S. Cl. 353/54; 353/52; 353/121

(57) ABSTRACT

A projector includes: an illumination device that emits illumination light; a light modulating device that modulates the illumination light on the basis of an input image signal; and a cooling device that cools the light modulating device according to a light amount of the illumination light.

### CROSS-REFERENCE

The entire disclosure of Japanese Patent Application No. 2009-178616 filed Jul. 31, 2009 is expressly incorporated by reference herein.

### BACKGROUND

1. Technical Field

The present invention relates to a projector, a computer program, an information storage medium, and a cooling control method.

2. Related Art

For example, JP-A-2005-121712 discloses a rear projector that detects, when a main switch of the rear projector is turned off, temperature using a first temperature sensor for detecting the temperature of an optical device having a liquid crystal panel or the like and a second temperature sensor for detecting the temperature of the air around the optical device and controls, while maintaining a state in which the temperature of the air around the optical device is equal to or lower than the temperature of the optical device, a cooling device having a Peltier element such that the temperatures fall to about the room temperature.

However, when a dimming section is provided between a light source and the optical device, in order to prevent moisture condensation, the projector needs to control the cooling device not only when the main switch is turned off but also when light is blocked by the dimming section.

### SUMMARY

An advantage of some aspects of the invention is to provide a projector, a computer program, an information storage medium, and a cooling control method that can appropriately prevent occurrence of moisture condensation by controlling a cooling device having a Peltier element.

According to an aspect of the invention, a projector includes: an illumination device that emits illumination light; a light modulating device that modulates the illumination light on the basis of an input image signal; and a cooling device that cools the light modulating device according to a light amount of the illumination light.

According to the aspect of the invention, the projector appropriately cools the light modulating device according to the light amount of the illumination light. Therefore, it is possible to prevent moisture condensation due to overcooling from occurring when the light amount of the illumination light is small.

The projector according to the aspect may further include a first temperature measuring section that measures first temperature that is the temperature of the light modulating device. The cooling device may cool, when the first temperature is lower than reference temperature at which moisture condensation occurs, the light modulating device such that the first temperature rises to be equal to or higher than the reference temperature. With such a configuration, it is possible to perform cooling corresponding to the temperature of the light modulating device and more appropriately prevent occurrence of moisture condensation.

The projector according to the aspect may further include a second temperature measuring section that measures second temperature that is the temperature on the outside of the light modulating device. The cooling device may cool, when the first temperature is lower than the second temperature, the light modulating device such that the first temperature rises to be equal to or higher than the second temperature. With such a configuration, since the temperature of a main body of the light modulating device is kept at temperature equal to or higher than the temperature around the light modulating device, it is possible to improve the effect of preventing occurrence of moisture condensation.

In the projector according to the aspect, the cooling device may suppress the cooling of the light modulating device when the light amount of the illumination light is a minimum. With such a configuration, since the cooling of the light modulating device by the cooling device is suppressed when the illumination light that reaches the light modulating device is a minimum, it is possible to prevent moisture condensation in the light modulating device.

The projector according to the aspect may further include an operation section that receives an instruction for image mute for hiding an image based on the image signal. The illumination device may suppress the light amount of the illumination light when the operation section receives the instruction for image mute. With such a configuration, since the light amount of the illumination light is suppressed during the image mute, it is possible to suppress an amount of consumption of electric power by the illumination device.

In the projector according to the aspect, the illumination device may release the suppression of the light amount of the illumination light when the instruction for image mute is cancelled. With such a configuration, since the suppression of the light amount of the illumination light is released in association with the cancellation of the image mute, it is possible to quickly enjoy an image based on the input image signal.

In the projector according to the aspect, the cooling device may suppress the cooling of the light modulating device when the instruction for image mute is received. With such a configuration, since cooling device suppresses the cooling of the light modulating device when the projector is set in the image mute, it is possible to appropriately prevent occurrence of moisture condensation due to a fall in the temperature of the light modulating device involved in a reduction in the light amount of the illumination light during the image mute.

In the projector according to the aspect, the cooling device may release the suppression of the cooling of the light modulating device when the instruction for image mute is cancelled. With such a configuration, since the cooling device releases the suppression of the cooling of the light modulating device in association with the illumination device releasing the suppression of the light amount of the illumination light according to the cancellation of the image mute, it is possible to appropriately cool the light modulating device.

In the projector according to the aspect, the illumination device may include: a light source that emits light; and a dimming device that emits, as the illumination light, light obtained by adjusting an amount of the light emitted by the light source. With such a configuration, even when a light source with many limitations on control of a light amount such as a discharge lamp is used, it is possible to relatively freely control the light amount of the illumination light.

In the projector according to the aspect, the dimming device of the illumination device may include: a dimming section provided between the light source and the light modulating device, the light from the light source being made incident on the dimming section; and an opening and closing section provided between the dimming section and the light modulating device and provided such that the light adjusted by the dimming device is made incident on the opening and closing section. The illumination device may drive, when the light amount of the illumination light is minimized, the dimming section such that an amount of light passing through the dimming section decreases to be equal to or smaller than a predetermined value and close the opening and closing section. With such a configuration, when an optical path is closed in a state in which the light source is on, since an amount of light passing through the optical path is limited to be equal to or smaller than the predetermined value by the dimming section and the light passed through the dimming section is blocked by the opening and closing section, it is possible to disperse thermal energy of the light emitted from the light source to the entire dimming device and cause the dimming device to absorb the thermal energy. In other words, since thermal damage to the opening and closing section can be reduced compared with thermal damage suffered by the opening and closing section when the optical path is closed by using only the opening and closing section, it is possible to reduce cost for the dimming device.

In the projector according to the aspect, the cooling device may include: a refrigerant pipe in which a refrigerant is encapsulated; and a heat exchange unit that lowers the temperature of the refrigerant encapsulated in the refrigerant pipe. With such a configuration, it is possible to provide a projector that more efficiently cools the light modulating device compared with an air cooling system by a cooling fan.

In the projector according to the aspect, the heat exchange unit of the cooling device may include: a Peltier element disposed to be thermally conductible to the refrigerant pipe, the Peltier element absorbing heat of the refrigerant; and a cooling fin that radiates the heat absorbed by the Peltier element. With such a configuration, it is possible to efficiently radiate the heat deprived from the refrigerant that circulates in the refrigerant pipe.

According to another aspect of the invention, a control method for a projector including an illumination device, a light modulating device, and a cooling device includes: causing the illumination device to emit illumination light; causing the light modulating device to modulate the illumination light on the basis of an input image signal; and causing the cooling device to cool the light modulating device according to a light amount of the illumination light. Therefore, it is possible to realize effects same as those of the projector according to the aspect explained above.

Besides the aspects of the projector and the control method for the projector, the invention may be configured as a computer program for realizing the control method with a computer included in the projector. Further, the invention may be configured as a recording medium having the computer program recorded thereon.

### BRIEF DESCRIPTION OF THE DRAWINGS

The invention will be described with reference to the accompanying drawings, wherein like numbers reference like elements.

FIG. 1 is a functional block diagram of a projector in a first embodiment.

FIG. 2 is a schematic plan sectional view of the projector in the first embodiment.

FIG. 3 is a diagram for explaining the operation of a dimming device in the first embodiment.

FIG. 4 is a diagram for explaining the operation of an opening and closing device in the first embodiment.

FIG. 5 is a functional block diagram of a cooling device in the first embodiment.

FIG. 6 is a diagram of a path of a refrigerant pipe in the first embodiment.

FIG. 7 is a flowchart for explaining a control procedure in the first embodiment.

FIG. 8 is a functional block diagram of a projector in a second embodiment.

FIG. 9 is a flowchart for explaining a control procedure in the second embodiment.

### DESCRIPTION OF EXEMPLARY EMBODIMENTS

Embodiments in which the invention is applied to a projector are explained below with reference to the accompanying drawings. The embodiments explained below by not means limit the content of the invention described in claims. All components described in the embodiments are not always essential as solving means of the invention described in claims.

### First Embodiment

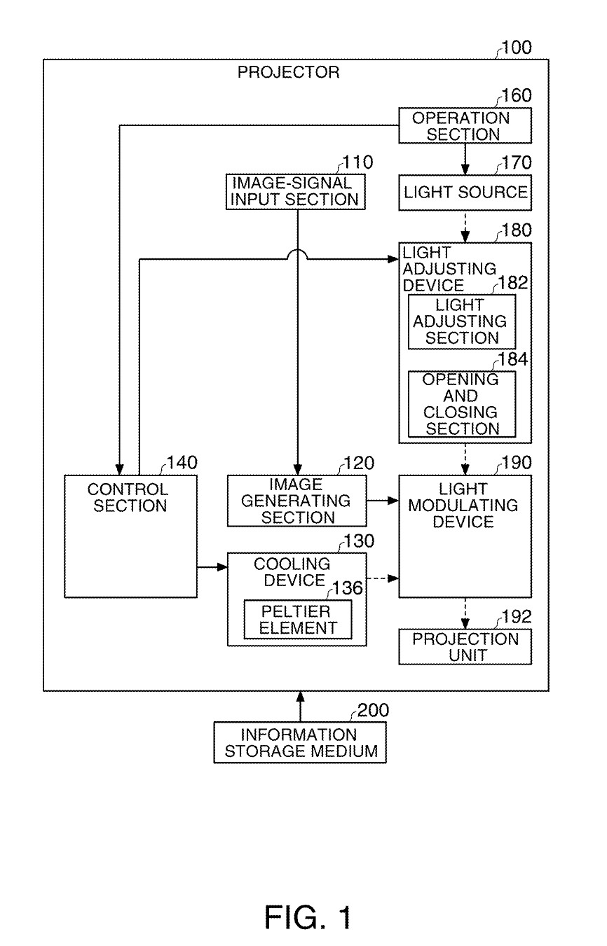

FIG. 1 is a functional block diagram of a projector 100 in a first embodiment. The projector 100 includes an operation section 160, a light source 170, a light modulating device 190 that modulates light from the light source 170 according to an image signal, a cooling device 130 having a Peltier element 136 connected thermally conductible to the light modulating device 190, a dimming device 180 provided between the light source 170 and the light modulating device 190, and a control section 140 that controls the dimming device 180 and controls the cooling device 130 according to a control state of the dimming device 180 to thereby adjust the temperature of the light modulating device 190. The light source 170 and the dimming device 180 respectively correspond to the light source and the dimming device included in the illumination device of this aspect of the invention.

The dimming device 180 includes a dimming section 182 that moves plural baffles to the inside and the outside of an optical path to thereby adjust an amount of light that passes through the optical path and an opening and closing section 184 that moves one baffle to the inside and the outside of the optical path to thereby open and close the optical path.

The projector 100 further includes an image-signal input section 110 that receives input of an image signal (e.g., an RGB signal) from a PC (Personal Computer) or the like, an image generating section 120 that generates an image on the basis of the image signal, and a projection unit 192 that projects the image.

The projector 100 may function as these sections using hardware explained below. For example, in the projector 100, an image input terminal, a converter, or the like may be used as the image-signal input section 110, an image processing circuit or the like may be used as the image generating section 120, a CPU or the like may be used as the control section 140, a remote controller, operation buttons, or the like may be used as the operation section 160, and a projection lens or the like including a zoom lens may be used as the projection unit 192. Details of the cooling device 130, the light source 170, the dimming device 180, and the light modulating device 190 are explained later.

The computer of the projector 100 may read a computer program stored in an information storage medium 200 and function as the control section 140 or the like. As such an information storage medium 200, for example, a CD-ROM, a DVD-ROM, a ROM, a RAM, an HDD, or the like can be applied.

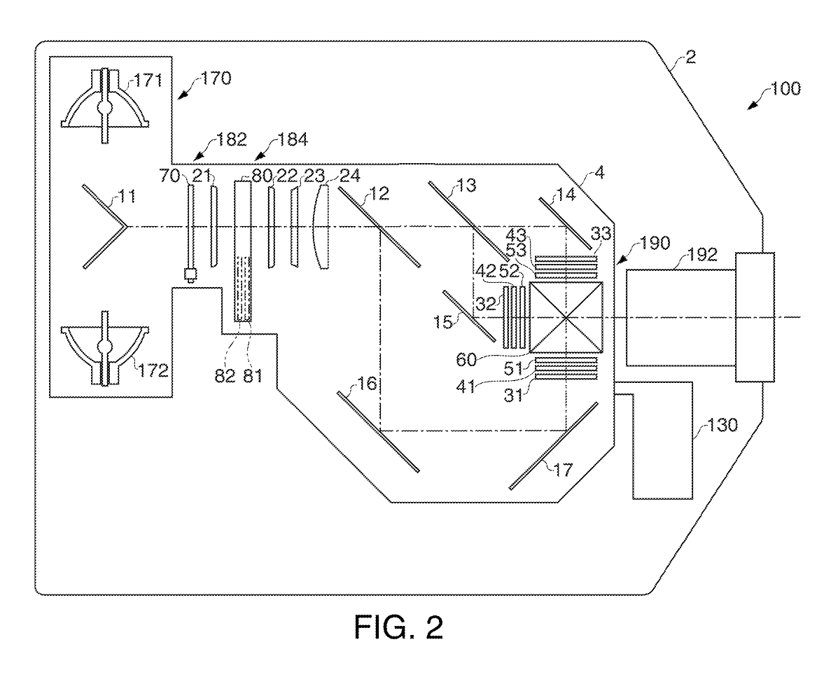

A flow of light in the projector 100 is explained. FIG. 2 is a schematic plan sectional view of the projector 100 in the first embodiment. In the projector 100, an optical component housing 4, the cooling device 130, the projection unit 192, and the like are housed in a housing 2. The optical component housing 4 houses the light source 170, the dimming section 182, the opening and closing section 184, the light modulating device 190, and the like.

The light source 170 includes two light source devices 171 and 172. Lights from the light source devices 171 and 172 are reflected by a reflection mirror 11 and output to a color separation optical system through a dimming mechanism 70, a first lens array 21, an opening and closing mechanism 80, a second lens array 22, a polarization conversion element 23, and a superimposing lens 24.

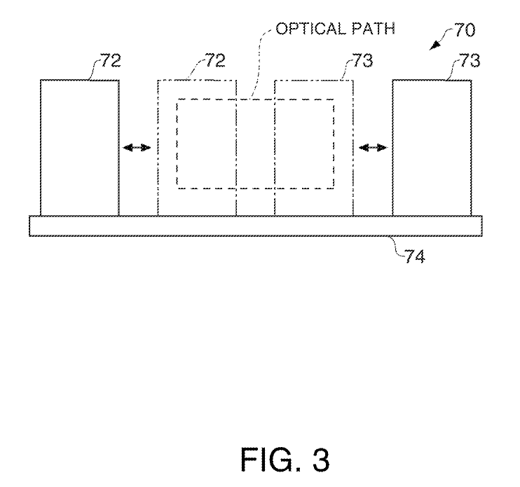

The dimming mechanism 70 and the opening and closing mechanism 80 are explained more in detail below. FIG. 3 is a diagram for explaining the operation of the dimming mechanism 70 in the first embodiment. The dimming mechanism 70 is a part of the dimming section 182 and includes baffles 72 and 73 and a supporting member 74 that slidably supports the baffles 72 and 73. The baffles 72 and 73 are driven by a not-shown motor according to control information received from the control section 140. A rectangular area indicated by a broken line in the figure represents a section of an optical path of light made incident on the dimming mechanism 70.

For example, when controlled to be opened, the baffles 72 and 73 move to positions where the baffles 72 and 73 do not block the optical path. When controlled to be closed, the baffles 72 and 73 move to positions where the baffles 72 and 73 block apart of the optical path while being spaced apart from each other.

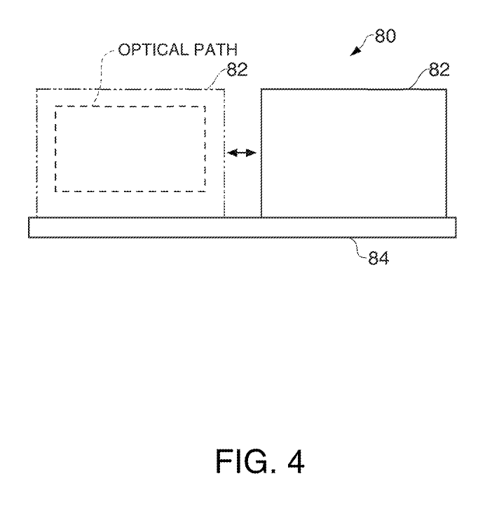

FIG. 4 is a diagram for explaining the operation of the opening and closing mechanism 80 in the first embodiment. The opening and closing mechanism 80 is a part of the opening and closing section 184 and includes a filter 81, a baffle 82, and a supporting member 84 that movably supports the filter 81 and the baffle 82. The filter 81 and the baffle 82 are driven by a not-shown motor according to control information received from the control section 140. The filter 81 is a filter for changing colors and brightness of an image according to a set color mode or the like. A rectangular area indicated by a broken line in the figure represents a section of an optical path of light made incident on the opening and closing mechanism 80.

For example, when controlled to be opened, the baffle 82 moves to a position where the baffle 82 does not block the optical path. When controlled to be closed, the baffle 82 moves to a position where the baffle 82 blocks the entire optical path.

A color separation optical system housed in the optical component housing 4 includes a dichroic mirror 12 that separates R light, reflection mirrors 16 and 17 that reflect the R light and lead the R light to a liquid crystal panel 41 for R light, a dichroic mirror 13 that separates light, from which the R light is separated, into G light and B light, a reflection mirror 15 that reflects the G light and leads the G light to a liquid crystal panel 42 for G light, and a reflection mirror 14 that reflects the B light and leads the B light to a liquid crystal panel 43 for B light.

A color combination optical system housed in the optical component housing 4 includes an incidence-side sheet polarizer 31 for R light, the liquid crystal panel 41, an emission-side sheet polarizer 51, an incidence-side sheet polarizer 32 for G light, the liquid crystal panel 42, an emission-side sheet polarizer 52, an incidence-side sheet polarizer 33 for B light, the liquid crystal panel 43, an emission-side sheet polarizer 53, and a cross dichroic prism 60 that combines the R light, the G light, and the B light transmitted through the emission-side sheet polarizers 51 to 53 and outputs combined light to the projection unit 192. The color combination optical system is a part of the light modulating device 190.

The cooling device 130 is formed to be thermally conductible to the light modulating device 190. The cooling device 130 is explained more in detail below.

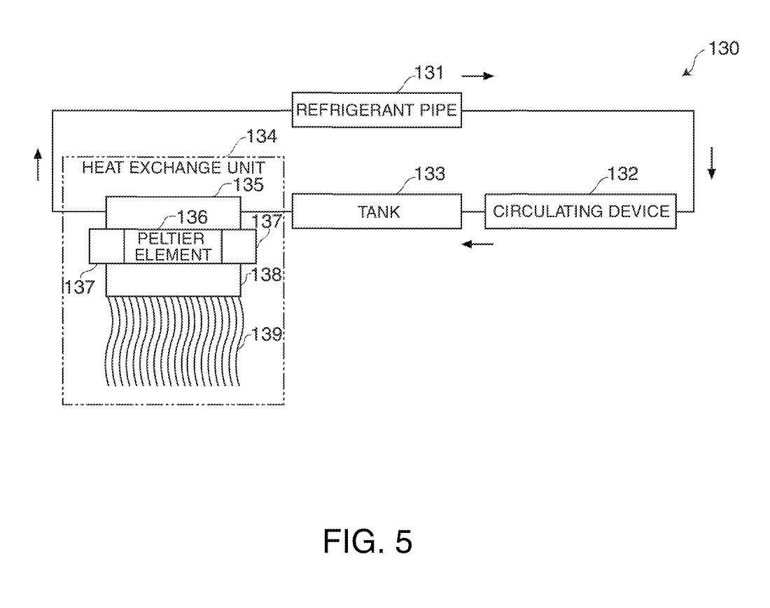

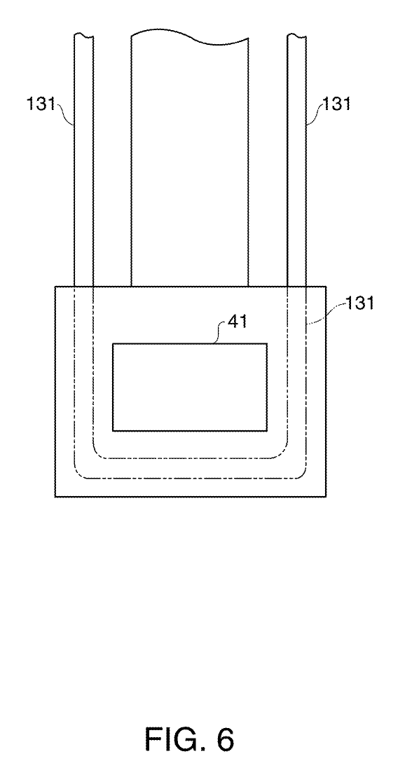

FIG. 5 is a functional block diagram of the cooling device 130 in the first embodiment. FIG. 6 is a diagram of a path of a refrigerant pipe 131 in the first embodiment.

The cooling device 130 includes the refrigerant pipe 131 in which a refrigerant is encapsulated, a circulating device 132 that circulates the refrigerant encapsulated in the refrigerant pipe 131, a tank 133 that temporarily stores the refrigerant, and a heat exchange unit 134 that adjusts the temperature of the refrigerant. The refrigerant pipe 131 is disposed to be thermally conductible to the liquid crystal panels 41 to 43. The refrigerant that absorbs heat from the liquid crystal panels 41 to 43 is sent to the heat exchange unit 134 by the circulating device 132 driven by electric power supplied from a not-shown power supply.

The heat exchange unit 134 includes a Peltier element 136, a partition plate 137 that supports the Peltier element 136, a heat exchanging section 135 provided on a heat absorption side of the Peltier element 136, and a plate member 138 and a fin member 139 provided on a heat radiation side of the Peltier element 136. The Peltier element 136 is electrically driven, heat is absorbed from the refrigerant, and the heat is radiated, whereby the refrigerant is cooled and sections around the liquid crystal panels 41 to 43 are cooled.

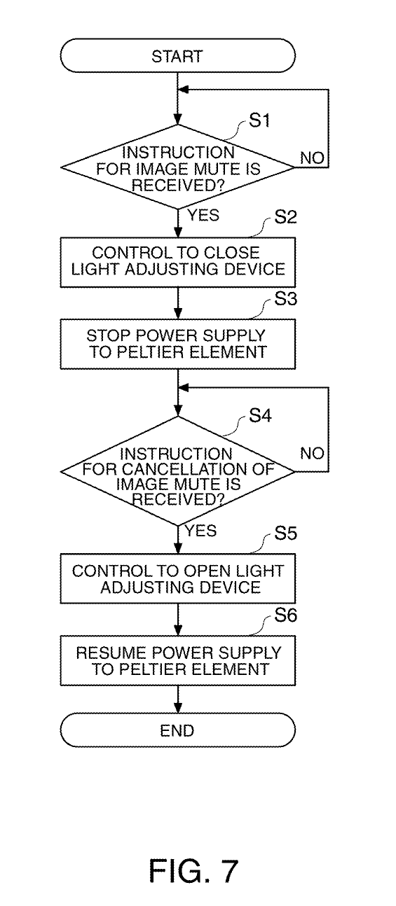

A procedure for cooling the light modulating device 190 using the cooling device 130 and the like is explained below. FIG. 7 is a flowchart for explaining a cooling procedure in the first embodiment.

A user temporarily stops projection of an image by the projector 100 by pressing an image mute button of a remote controller. Specifically, when the projector 100 receives an instruction for image mute, the projector 100 temporarily hides an image based on an input image. The control section 140 determines, on the basis of information received from the operation section 160, whether the instruction for image mute is received (step S1).

When the instruction for image mute is received, the control section 140 controls the dimming section 182 and the opening and closing section 184 and moves the baffles 72, 73, and 82 to closed positions indicated by alternate long and short dashes lines in FIGS. 3 and 4, i.e., closes the dimming device 180 to suppress alight amount of illumination light (step S2). The control section 140 controls the cooling device 130 and stops power supply to the Peltier element 136 to suppress cooling of the light modulating device 190 (step S3).

The projector 100 can suppress, by stopping the power supply to the Peltier element 136, a temperature fall around the liquid crystal panels 41 to 43 in the case of blocking of light by the baffles 72, 73, and 82 because the refrigerant circulates around the liquid crystal panels 41 to 43 without heat thereof being absorbed.

The user resumes display of the image by the projector 100 by pressing the image mute button of the remote controller again. The control section 140 determines, on the basis of information received from the operation section 160, whether an instruction for cancellation of image mute is received (step S4).

When the operation section 160 receives the instruction for cancellation of image mute, the control section 140 controls the dimming section 182 and the opening and closing section 184 and moves the baffles 72, 73, and 82 to open positions indicated by solid lines in FIGS. 3 and 4, i.e., opens the dimming device 180 to release the suppression of the light amount of the illumination light (step S5). The control section 140 controls the cooling device 130 and resumes the power supply to the Peltier element 136 to release the suppression of the cooling of the light modulating device 190 (step S6).

The projector 100 lowers the temperature of the refrigerant again by resuming the power supply to the Peltier element 136. It is possible to suppress a temperature rise around the liquid crystal panels 41 to 43 without suppressing the light amount of the illumination light because the cooled refrigerant circulates through the refrigerant pipe 131 laid around the liquid crystal panels 41 to 43.

As explained above, according to this embodiment, the projector 100 can more appropriately prevent occurrence of moisture condensation in the light modulating device 190 by controlling the cooling device 130 having the Peltier element 136 according to an adjustment state of the dimming device 180.

According to this embodiment, the projector 100 can prevent occurrence of moisture condensation in the light modulating device 190 by stopping the operation of the Peltier element 136 when the dimming section 182 is closed.

According to this embodiment, the projector 100 can prevent occurrence of moisture condensation in the light modulating device 190 by stopping the operation of the Peltier element 136 when the opening and closing section 184 is completely closed. According to this embodiment, since the plural baffles 72 and 73 are arranged spaced apart from each other in front of one baffle 82 that completely blocks the optical path, the projector 100 can reduce an amount of light irradiated on the baffle 82. Therefore, it is possible to suppress a temperature rise on the baffle 82.

### Second Embodiment

In the first embodiment, the projector 100 controls the cooling device 130 according to the instruction for image mute. However, the projector 100 may control the cooling device 130 according to the temperature of the light modulating device 190.

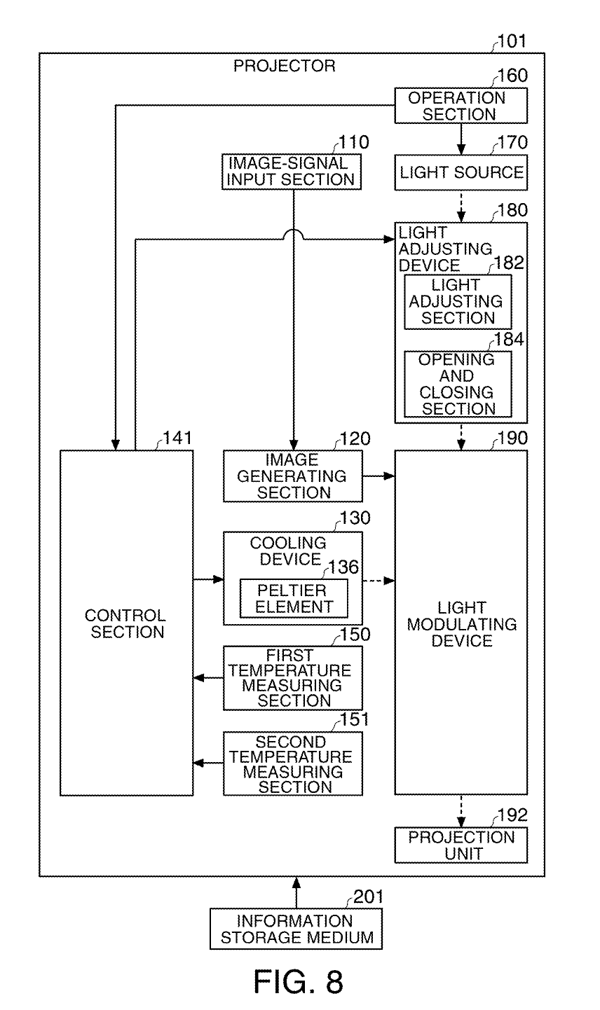

FIG. 8 is a functional block diagram of a projector 101 according to a second embodiment. The projector 101 includes, in addition to the components of the projector 100, a first temperature measuring section 150 that measures first temperature that is the temperature of the light modulating device 190 and a second temperature measuring section 151 that measures second temperature that is the temperature on the outside of the light modulating device 190.

A control section 141 controls, when the first temperature is lower than the second temperature, the cooling device 130 such that the first temperature rises to be equal to or higher than the second temperature. As in the first embodiment, the projector 101 may read a computer program from an information storage medium 201 and function as the control section 141 or the like.

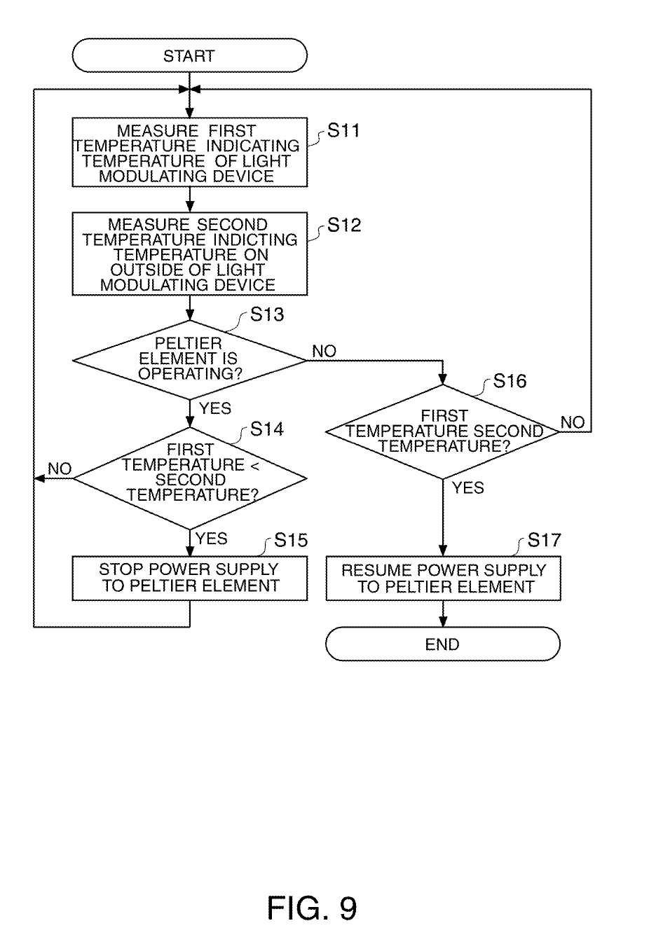

A procedure for cooling control by the control section 141 and the like is explained below. FIG. 9 is a flowchart for explaining a control procedure in the second embodiment. The first temperature measuring section 150 measures first temperature indicating the temperature of the light modulating device 190 (step S11). The second temperature measuring section 151 measures second temperature indicating the temperature on the outside of the light modulating device 190 (step S12).

The control section 141 determines whether the Peltier element 136 is operating (step S13). When the Peltier element 136 is operating, the control section 141 determines whether the first temperature is lower than the second temperature (step S14).

When the first temperature is lower than the second temperature, the control section 141 controls the cooling device 130 to stop power supply to the Peltier element 136 (step S15). Consequently, the operation of the Peltier element 136 is stopped. When the first temperature is equal to or higher than the second temperature, the power supply to the Peltier element 136 is continued.

When the operation of the Peltier element 136 is stopped, the control section 141 determines whether the first temperature is equal to or higher than the second temperature (step S16). When the first temperature is equal to or higher than the second temperature, the control section 141 controls the cooling device 130 to resume the power supply to the Peltier element 136 (step S17). Consequently, the Peltier element 136 operates.

As in the first embodiment, the control section 141 controls the cooling device 130 according to an adjustment state of the dimming device 180.

As explained above, according to this embodiment, the projector 101 realizes actions and effects same as those in the first embodiment. According to this embodiment, the projector 101 can prevent occurrence of moisture condensation in the light modulating device 190 by controlling the cooling device 130 such that the temperature of the light modulating device 190 rises to be equal to or higher than the temperature on the outside.

### Other Embodiments

The application of the invention is not limited to the embodiments explained above. Various modifications of the embodiments are possible. For example, in the second embodiment, the projector 101 includes the second temperature measuring section 151. However, the second temperature measuring section 151 is not essential.

For example, when the first temperature measured by the first temperature measuring section 150 is lower than reference temperature (e.g., 0 degree or 10 degrees) at which moisture condensation occurs, the control section 141 may control the cooling device 130 such that the first temperature rises to be equal to or higher than the reference temperature.

Therefore, the projector 101 can prevent occurrence of moisture condensation in the light modulating device 190 by controlling the cooling device 130 such that the temperature of the light modulating device 190 rises to be equal to or higher than the reference temperature.

As the control for preventing moisture condensation, instead of the control for stopping the power supply to the Peltier element 136, the control section 141 may reverse a flow of heat in the Peltier element 136 and heat the refrigerant by reversing the direction of electric current flowing to the Peltier element 136.

In the example explained in the embodiments, the circulating device 132 circulates the refrigerant through the refrigerant pipe 131 even while the power supply to the Peltier element 136 is stopped. However, the power supply to the circulating device 132 may be stopped when a predetermined time elapses after the power supply to the Peltier element 136 is stopped. The power supply to the circulating device 132 may be stopped when there is no temperature difference between the refrigerant and the light modulating device 190. With such a configuration, it is possible to save electric power consumed by the cooling device 130 while a light amount of illumination light made incident on the liquid crystal panels is suppressed, for example, during image mute.

A driving system for the baffles 72, 73, and 82 is not limited to the slide driving system and may be, for example, a rotation driving system. The dimming device 180 may include one of the dimming section 182 and the opening and closing section 184. The filter 81 in the opening and closing mechanism 80 is not essential.

As the control corresponding to a control state of the dimming device 180, the control sections 140 and 141 may perform control corresponding to not only the open state and the closed state but also, for example, transmittance in the dimming device 180 (e.g., control for stopping the cooling by the cooling device 130 when transmittance of light in the dimming device 180 is equal to or lower than a reference value). In the embodiments, as the dimming section 182 and the opening and closing section 184, the dimming section and the opening and closing section that mechanically move the positions of the baffles are explained as an example. However, the dimming section and the opening and closing section can be respectively replaced with light modulating elements such as liquid crystal panels.

In FIG. 2, the two light source devices 171 and 172 are provided as the light source 170. However, the light source 170 may be one light source device or may be three or more light source devices. The projectors 100 and 101 are 3CCD liquid crystal projectors but may be 1CCD liquid crystal projectors.

The projectors 100 and 101 are not limited to liquid crystal projectors (a transmission type or a reflection type such as LCOS) and may be, for example, projectors employing digital micro-mirror devices. The functions of the projectors 100 and 101 may be distributed to plural apparatuses (e.g., a PC and a projector).

What is claimed is:

1. A projector comprising:
an illumination device that emits illumination light;
a light modulating device that modulates the illumination light on the basis of an input image signal; and
a cooling device that cools the light modulating device according to a light amount of the illumination light.

2. The projector according to claim 1, further comprising a first temperature measuring section that measures first temperature that is temperature of the light modulating device, wherein
the cooling device cools, when the first temperature is lower than reference temperature at which moisture condensation occurs, the light modulating device such that the first temperature rises to be equal to or higher than the reference temperature.

3. The projector according to claim 2, further comprising a second temperature measuring section that measures second temperature that is temperature on an outside of the light modulating device, wherein
the cooling device cools, when the first temperature is lower than the second temperature, the light modulating device such that the first temperature rises to be equal to or higher than the second temperature.

4. The projector according to claim 1, wherein the cooling device suppresses the cooling of the light modulating device when the light amount of the illumination light is a minimum.

5. The projector according to claim 1, further comprising an operation section that receives an instruction for image mute for hiding an image based on the image signal, wherein
the illumination device suppresses the light amount of the illumination light when the operation section receives the instruction for image mute.

6. The projector according to claim 5, wherein the illumination device releases the suppression of the light amount of the illumination light when the instruction for image mute is cancelled.

7. The projector according to claim 5, wherein the cooling device suppresses the cooling of the light modulating device when the instruction for image mute is received.

8. The projector according to claim 7, wherein the cooling device releases the suppression of the cooling of the light modulating device when the instruction for image mute is cancelled.

9. The projector according to claim 1, wherein the illumination device includes:
a light source that emits light; and
a dimming device that emits, as the illumination light, light obtained by adjusting an amount of the light emitted by the light source.

10. The projector according to claim 9, wherein
the dimming device includes:
a dimming section provided between the light source and the light modulating device, the light from the light source being made incident on the dimming section; and
an opening and closing section provided between the dimming section and the light modulating device and provided such that the light adjusted by the dimming device is made incident on the opening and closing section, and
the illumination device drives, when the light amount of the illumination light is minimized, the dimming section such that an amount of light passing through the dimming section decreases to be equal to or smaller than a predetermined value and closes the opening and closing section.

11. The projector according to claim 1, wherein
the cooling device includes:
a refrigerant pipe in which a refrigerant is encapsulated; and
a heat exchange unit that lowers temperature of the refrigerant encapsulated in the refrigerant tube.

12. The projector according to claim 11, wherein
the heat exchange unit of the cooling device includes:
a Peltier element disposed to be thermally conductible to the refrigerant pipe, the Peltier element absorbing heat of the refrigerant; and
a cooling fin that radiates the heat absorbed by the Peltier element.

13. A control method for a projector including an illumination device, a light modulating device, and a cooling device, the control method comprising:
causing the illumination device to emit illumination light;
causing the light modulating device to modulate the illumination light on the basis of an input image signal; and
causing the cooling device to cool the light modulating device according to a light amount of the illumination light.

14. The control method according to claim 13, further comprising:
measuring first temperature that is temperature of the light modulating device; and
causing the cooling device to cool, when the first temperature is lower than reference temperature at which moisture condensation occurs, the light modulating device such that the first temperature rises to be equal to or higher than the reference temperature.

15. The control method according to claim 14, further comprising:
measuring second temperature that is temperature on an outside of the light modulating device; and
causing the cooling device to cool, when the first temperature is lower than the second temperature, the light modulating device such that the first temperature rises to be equal to or higher than the second temperature.

16. The control method according to claim 13, further comprising causing the cooling device to suppress the cooling of the light modulating device when the light amount of the illumination light is a minimum.

17. The control method according to claim 13, further comprising causing the illumination device to suppress the light amount of the illumination light when an instruction for image mute for hiding an image based on the image signal is received.

18. The control method according to claim 17, further comprising causing the illumination device to release the suppression of the light amount of the illumination light when the instruction for image mute is cancelled.

19. The control method according to claim 17, further comprising causing the cooling device to suppress the cooling of the light modulating device when the instruction for image mute is received.

20. The control method according to claim 19, further comprising causing the cooling device to release the suppression of the cooling of the light modulating device when the instruction for image mute is cancelled.
